(19) United States
(12) Patent Application Publication
(10) Pub. No.: US 2025/0376267 A1
(43) Pub. Date: Dec. 11, 2025

(54) SYSTEM FOR DISPLAYING IMAGE OF FLIGHT PATH VECTOR SYMBOL AND FLIGHT DIRECTOR SYMBOL TO PREVENT OCCLUSION OF RUNWAY ENVIRONMENT AND METHOD THEREFOR

(71) Applicant: Rockwell Collins, Inc., Cedar Rapids, IA (US)

(72) Inventors: Nixon G. Lange, Tigard, OR (US); Zoubair Entezari, Woodburn, OR (US)

(21) Appl. No.: 18/740,234

(22) Filed: Jun. 11, 2024

(51) Int. Cl. B64D 43/00; G01C 23/00; G02B 27/01; G08G 5/00; G09G 5/377

(52) U.S. Cl. CPC B64D 43/00; G01C 23/005; G02B 27/0101; G08G 5/30; G09G 5/377

(57) ABSTRACT

A system includes a display unit, an vision system (VS) sensor unit, and a computing device. The computing device is configured to: generate display images having display symbols overlaid on an image or another image associated with the image. The display symbols include a flight path vector (FPV) symbol and a flight director (FD) symbol. At least one portion of the FPV symbol and/or FD symbol is hidden or removed from a given display image such that the FPV symbol and FD symbol do not occlude portion(s) of the runway environment; and output the display images to the display unit. The display unit is configured to display the display images including the given display image to a user.

### BACKGROUND

Currently, for electronic flight vision systems (EFVSs), there are cases where an electronic visions system (EVS) camera detects the runway environment (e.g., a runway, runway threshold, runway lights, and/or a touchdown zone), but a flight path vector (FPV) symbol and/or a flight director (FD) symbol (e.g., depicted by a head-up display (HUD)) can obstruct a pilot's view of the runway environment. Such occlusion can lead to a delay in a pilot recognizing that the runway environment is visible on the HUD, particularly when the aircraft is farther away from the runway environment such that the runway environment is small in relation to the FPV symbol.

### SUMMARY

In one aspect, embodiments of the inventive concepts disclosed herein are directed to a system. The system may include at least one display unit. The system may include at least one vision system (VS) sensor unit installed in an aircraft, each of the at least one VS sensor unit comprising at least one sensor and at least one VS processor, wherein the at least one VS sensor unit is configured to provide real-time images of views of an environment external to the aircraft. The system may include at least one computing device, each of the at least one computing device comprising at least one processor, wherein the at least one computing device, the at least one VS sensor unit, and the at least one display unit are communicatively coupled at one or more given times, wherein the at least one computing device is configured to: receive at least some of the images from one or more of the at least one VS sensor unit, wherein one or more of the at least some of the images include views of a runway environment; generate real-time display images, wherein each of one or more of the display images have display symbols overlaid on one of (a) a given image of the one or more of the at least some of the images or (b) an image associated with the given image, wherein the display symbols comprise a flight path vector (FPV) symbol and a flight director (FD) symbol, wherein at least one portion of the FPV symbol is hidden or removed from a given display image of the one or more of the display images such that the FPV symbol does not occlude at least one portion of the runway environment, wherein at least one portion of the FD symbol is hidden or removed from the given display image of the one or more of the display images such that the FD symbol does not occlude at least one other portion of the runway environment; and output one or more of the display images to one or more of the at least one display unit. The one or more of the at least one display unit is configured to display at least one display image of the one or more of the display images to a user, the at least one display image including the given display image.

In a further aspect, embodiments of the inventive concepts disclosed herein are directed to a method. The method may include: providing, by at least one vision system (VS) sensor unit installed in an aircraft, real-time images of views of an environment external to the aircraft, each of the at least one VS sensor unit comprising at least one sensor and at least one VS processor; receiving, by at least one processor of at least one computing device, at least some of the images from one or more of the at least one VS sensor unit, wherein one or more of the at least some of the images include views of a runway environment, each of the at least one computing device comprising the at least one processor, wherein the at least one computing device, the at least one VS sensor unit, and at least one display unit are communicatively coupled at one or more given times; generating, by the at least one processor of the at least one computing device, real-time display images, wherein each of one or more of the display images have display symbols overlaid on one of (a) a given image of the one or more of the at least some of the images or (b) an image associated with the given image, wherein the display symbols comprise a flight path vector (FPV) symbol and a flight director (FD) symbol, wherein at least one portion of the FPV symbol is hidden or removed from a given display image of the one or more of the display images such that the FPV symbol does not occlude at least one portion of the runway environment, wherein at least one portion of the FD symbol is hidden or removed from the given display image of the one or more of the display images such that the FD symbol does not occlude at least one other portion of the runway environment; outputting, by the at least one processor of the at least one computing device, one or more of the display images to one or more of the at least one display unit; and displaying, by the one or more of the at least one display unit, at least one display image of the one or more of the display images to a user, the at least one display image including the given display image.

### BRIEF DESCRIPTION OF THE DRAWINGS

Implementations of the inventive concepts disclosed herein may be better understood when consideration is given to the following detailed description thereof. Such description makes reference to the included drawings, which are not necessarily to scale, and in which some features may be exaggerated, and some features may be omitted or may be represented schematically in the interest of clarity. Like reference numerals in the drawings may represent and refer to the same or similar element, feature, or function. In the drawings:

FIG. 1 shows an exemplary embodiment of a system according to the inventive concepts disclosed herein.

FIG. 2 shows an exemplary embodiment of a cockpit of an aircraft of the system of FIG. 1 according to the inventive concepts disclosed herein.

FIGS. 3A and 3B show exemplary embodiments of exemplary display images displayed by a display unit of FIG. 1 at different times according to the inventive concepts disclosed herein.

FIG. 4A shows an exemplary embodiment of an exemplary display image at first time when an FPV symbol and an FD symbol does not occlude a portion of a runway environment according to the inventive concepts disclosed herein.

FIG. 4B shows an exemplary embodiment of an exemplary image associated with the display image of FIG. 4A according to the inventive concepts disclosed herein.

FIG. 5A shows an exemplary embodiment of an exemplary display image at second time when the FPV symbol and the FD symbol have hidden or removed portions so as to prevent occlusion of a portion of a runway environment according to the inventive concepts disclosed herein.

FIG. 5B shows an exemplary embodiment of an exemplary image associated with the display image of FIG. 5A according to the inventive concepts disclosed herein.

FIGS. 6A, 6B, 7A, 7B, 8A, and 8B show exemplary embodiments of the FPV symbol and the FD symbol having hidden or removed portions according to the inventive concepts disclosed herein.

FIG. 9 is a diagram of an exemplary embodiment of a method according to the inventive concepts disclosed herein.

### DETAILED DESCRIPTION

Before explaining at least one embodiment of the inventive concepts disclosed herein in detail, it is to be understood that the inventive concepts are not limited in their application to the details of construction and the arrangement of the components or steps or methodologies set forth in the following description or illustrated in the drawings. In the following detailed description of embodiments of the instant inventive concepts, numerous specific details are set forth in order to provide a more thorough understanding of the inventive concepts. However, it will be apparent to one of ordinary skill in the art having the benefit of the instant disclosure that the inventive concepts disclosed herein may be practiced without these specific details. In other instances, well-known features may not be described in detail to avoid unnecessarily complicating the instant disclosure. The inventive concepts disclosed herein are capable of other embodiments or of being practiced or carried out in various ways. Also, it is to be understood that the phraseology and terminology employed herein is for the purpose of description and should not be regarded as limiting.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only, and should not be construed to limit the inventive concepts disclosed herein in any way unless expressly stated to the contrary.

Further, unless expressly stated to the contrary, “or” refers to an inclusive or and not to an exclusive or. For example, a condition A or B is satisfied by anyone of the following: A is true (or present), and B is false (or not present), A is false (or not present) and B is true (or present), and both A and B are true (or present).

In addition, use of the “a” or “an” are employed to describe elements and components of embodiments of the instant inventive concepts. This is done merely for convenience and to give a general sense of the inventive concepts, and “a” and “an” are intended to include one or at least one and the singular also includes the plural unless it is obvious that it is meant otherwise.

Finally, as used herein any reference to “one embodiment,” or “some embodiments” means that a particular element, feature, structure, or characteristic described in connection with the embodiment is included in at least one embodiment of the inventive concepts disclosed herein. The appearances of the phrase “in some embodiments” in various places in the specification are not necessarily all referring to the same embodiment, and embodiments of the inventive concepts disclosed may include one or more of the features expressly described or inherently present herein, or any combination of sub-combination of two or more such features, along with any other features which may not necessarily be expressly described or inherently present in the instant disclosure.

Broadly, embodiments of the inventive concepts disclosed herein may be directed to a system (e.g., an aircraft system or a system including an aircraft and an offboard device) and a method configured to generate and/or display real-time display images. Each of one or more of the display images may have display symbols overlaid on one of a image or an image associated with the image. The display symbols may comprise a flight path vector (FPV) symbol and a flight director (FD) symbol, wherein at least one portion of the FPV and/or of the FD symbol is hidden or removed from a given display image of the one or more of the display images such that the FPV and/or FD symbol does not occlude at least one portion of the runway environment (e.g., a runway, runway threshold, runway lights, and/or a touchdown zone).

Some embodiments may provide an enhancement to an FPV symbol and/or an FD symbol for electronic flight vision system (EFVS) identification by a pilot of a runway environment during an approach and/or landing procedure(s), such as during day or night.

Some embodiments may include removing or hiding portion(s) (e.g., top, bottom, and/or a side(s) portion(s)) of the FPV symbol and/or the FD symbol. Some embodiments may still allow for pilot tracking of the FPV symbol against the FD symbol while increasing a visibility of the runway environment.

In some embodiments, removal or hiding of portion(s) of the FPV symbol and/or the FD symbol can be performed automatically by the system or manually activated/deactivated by a pilot. Such removal or hiding can be manually or automatically performed similar to declutter functionality and/or incorporated as part of the declutter functionality.

Some embodiments may improve situational awareness of a pilot, especially early in an approach, such as by reducing clutter and by providing a simplified and/or minimalistic set of useful information to achieve operational objectives.

An FPV may be approximately instantaneous (e.g., instantaneous, or the FPV may be filtered or smoothed in some cases) projection of the current aircraft trajectory. The FPV can be readily depicted as angular offsets from an aircraft pitch angle and a lateral pointing angle (also known as a heading). As the FPV may be an instantaneous depiction of a difference between the trajectory and the pointing angle, the FPV may not project future states accurately when the aircraft is maneuvering (e.g., turning or changing roll or pitch angles).

The FPV is where an aircraft is headed, which might not be where the aircraft is pointed. For example, such data of where the aircraft is headed could come from an inertial system, such as an inertial reference system (IRS), an attitude and heading reference system (AHARS), and/or other sensors and/or systems, such as microelectromechanical systems (MEMSs), of the aircraft capable of measuring and reporting aircraft accelerations, velocities, and/or orientation.

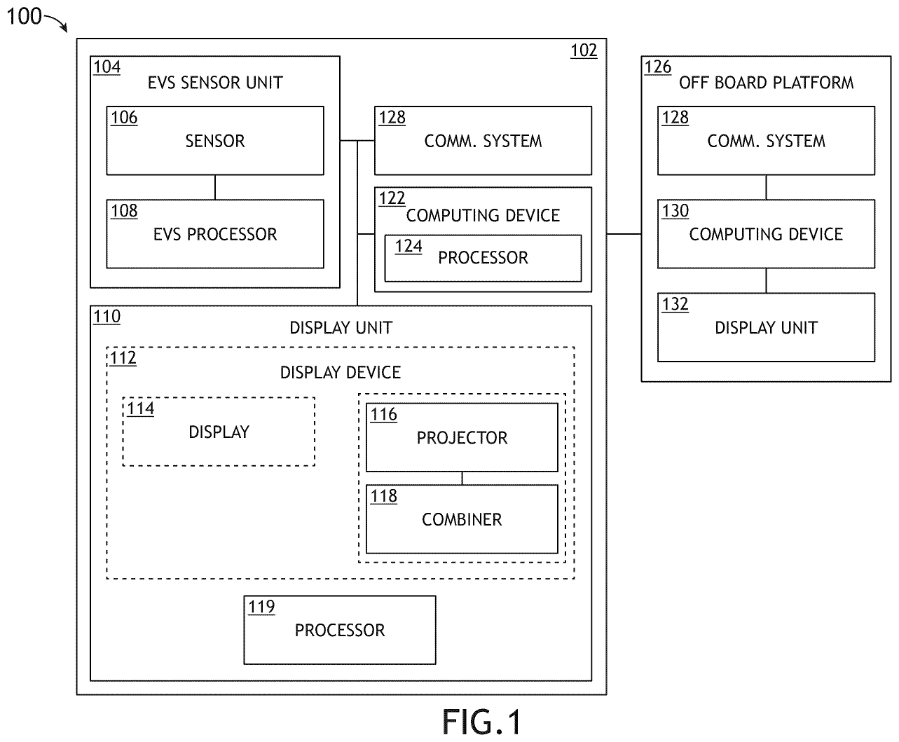

Referring now to FIG. 1, an exemplary embodiment of a system 100 according to the inventive concepts disclosed herein is depicted. In some embodiments, the system may include an aircraft 102 and/or at least one offboard platform 126, some or all of which may be communicatively coupled at any given time.

In some embodiments, the aircraft 102 may include at least one onboard pilot and may be a single-piloted or multiple-piloted aircraft; in some embodiments, the aircraft 102 may be an uncrewed aerial system (UAS) (e.g., a remote-piloted UAS and/or an autonomous UAS). In some embodiments, the aircraft 102 may include at least one user (e.g., flight crew and/or pilot(s)), at least one display unit 112, at least one computing device 122, at least one VS sensor unit, and/or at least one communication system 128, some or all of which may be communicatively coupled at any given time.

In some embodiments, the at least one display unit 110, the at least one computing device 122, the at least one VS sensor unit, and/or the at least one communication system 128 may be implemented as a single computing device or any number of computing devices configured to perform (e.g., collectively perform if more than one computing device) any or all of the operations disclosed throughout. For example, in some embodiments, the at least one display unit 110, the at least one computing device 122, the at least one VS sensor unit, and/or the at least one communication system 128 may be installed in the aircraft, the offboard platform 126, or some combination thereof.

In some embodiments, a user may be a pilot or crew member, who may be located onboard the aircraft 102 or at the offboard platform 126. For example, the user may interface with the system 100 via at least one user interface. The at least one user interface may be implemented as any suitable user interface, such as a touchscreen (e.g., of the display unit 110 and/or another display unit), a multipurpose control panel, a control panel integrated into a flight deck, a cursor control panel (CCP) (sometimes referred to as a display control panel (DCP)), a keyboard, a mouse, a trackpad, at least one hardware button, a switch, an eye tracking system, and/or a voice recognition system. The user interface may be configured to receive at least one user input and to output the at least one user input to a computing device (e.g., 122). For example, a pilot of the aircraft 102 may be able to interface with the user interface to: engage (or disengage) a mode to cause removal or hiding of portion(s) of the FPV symbol and/or of the FD symbol that would occlude portion(s) of a runway environment (e.g., a runway, runway threshold, runway lights, and/or a touchdown zone) in a display image to be displayed by the display unit 110. For example, such user inputs may be output to a computing device (e.g., 122).

The VS sensor unit may be implemented as any suitable computing device, such as at least one electronic visions system (EVS) sensor unit 104 (e.g., including a multi-spectral sensor that provides real-time video of the outside world), at least one synthetic vision system (SVS) sensor unit (e.g., that generates a synthetically generated image of the outside world aligned with an orientation of a pilot based at least on sensor data), and/or at least one combined vision system (CVS) sensor unit (e.g., that includes an EVS and an SVS). For example, the EVS sensor unit 104 may be or may include a multi-spectral sensor that provides real-time video of the outside world to the computing device 122. The VS sensor unit may be installed in the aircraft 102. Each of the at least one VS sensor unit may include at least one sensor 106 and/or at least one VS processor 108, some or all of which may be communicatively coupled at any given time. The at least one VS sensor unit may be configured to provide real-time images (e.g., sensor images and/or synthetic images) of views of an environment external to the aircraft 102. For example, the images may include views of a runway environment (e.g., a runway, runway threshold, runway lights, and/or a touchdown zone) during performance of an approach and/or landing procedure.

The at least one computing device 122 may be implemented as and/or may include any suitable computing device, such as head-up display (HUD) computing device associated with a PDU. For example, the HUD computing device may use information obtained from various avionics to create HUD symbols for airspeed, attitude, altitude, and navigation. For example, the computing device 122 may include at least one processor 124, at least one memory, and/or at least one storage, some or all of which may be communicatively coupled at any given time. For example, the at least one processor 124 may include at least one central processing unit (CPU), at least one graphics processing unit (GPU), at least one controller, at least one field-programmable gate array (FPGA), at least one application specific integrated circuit (ASIC), at least one digital signal processor, at least one virtual machine (VM) running on at least one processor, and/or the like configured to perform (e.g., collectively perform) any of the operations disclosed throughout. For example, the at least one processor 124 may include a CPU and a GPU configured to perform (e.g., collectively perform) any of the operations disclosed throughout. The processor 124 may be configured to run various software applications or computer code stored (e.g., maintained) in a non-transitory computer-readable medium (e.g., memory and/or storage) and configured to execute various instructions or operations. The processor 124 of the computing device 122 may be configured to perform any or all of the operations disclosed throughout. In some embodiments, the at least one processor 124 and/or the computing device 122 may be configured to: receive at least some of the images from one or more of the at least one VS sensor unit, wherein one or more of the at least some of the images include views of a runway environment (e.g., a runway, runway threshold, runway lights, and/or a touchdown zone); generate real-time display images, wherein each of one or more of the display images have display symbols overlaid on one of (a) a given image of the one or more of the at least some of the images or (b) an image associated with the given image, wherein the display symbols comprise a flight path vector (FPV) symbol and a flight director (FD) symbol, wherein at least one portion of the FPV symbol is hidden or removed from a given display image of the one or more of the display images such that the FPV symbol does not occlude at least one portion of the runway environment (e.g., a runway, runway threshold, runway lights, and/or a touchdown zone), wherein at least one portion of the FD symbol is hidden or removed from the given display image of the one or more of the display images such that the FD symbol does not occlude at least one other portion of the runway environment (e.g., a runway, runway threshold, runway lights, and/or a touchdown zone); and/or output one or more of the display images to one or more of the at least one display unit 110, the at least one display image including the given display image.

The display unit 110 may be implemented as any suitable computing device, such as a pilot display unit (PDU) computing device, a primary flight display (PFD) unit, a head-down display (HDD) unit, and/or a multi-function window (MFW) display unit. As shown in FIG. 1, the display unit 110 may include at least one display device 112 (e.g., which may be or include (a) at least one display 114 and/or (b) at least one projector 116 and/or combiner 118), at least one processor 119, at least one memory, and/or at least one storage, some or all of which may be communicatively coupled at any given time. For example, the display unit 110 may be implemented as PDU, which may be or include an overhead unit (e.g., the projector 116 and the combiner 118). For example, the at least one processor 119 may include at least one central processing unit (CPU), at least one graphics processing unit (GPU), at least one controller, at least one field-programmable gate array (FPGA), at least one application specific integrated circuit (ASIC), at least one digital signal processor, at least one virtual machine (VM) running on at least one processor, and/or the like configured to perform (e.g., collectively perform) any of the operations disclosed throughout. For example, the at least one processor 119 may include a CPU and a GPU configured to perform (e.g., collectively perform) any of the operations disclosed throughout. The processor 119 may be configured to run various software applications or computer code stored (e.g., maintained) in a non-transitory computer-readable medium (e.g., memory and/or storage) and configured to execute various instructions or operations. The processor 119 may be configured to perform any or all of the operations disclosed throughout. For example, the at least one processor 119 may be configured to: cause the display device 112 to display at least one display image of the one or more of the display images to a user. The at least one display device 112 may be configured to (e.g., collectively configured to, if more than one display device): display any or all display images to the user.

The communication system 128 may be any suitable communication system configured to communicate with the at least one offboard platform 126 at any given time. For example, the communication system 128 may include antenna(s), radio(s), and/or processor(s), some or all which may be communicatively coupled at any given time.

In some embodiments, the at least one offboard platform 126 may be any suitable offboard site (e.g., a ground site, such as an air traffic control tower) and/or offboard mobile platform (e.g., another vehicle). In some embodiments, the offboard platform 126 may include at least one user (e.g., flight crew and/or pilot(s)), at least one computing device 130, at least one display unit 132, and/or at least one communication system, some or all of which may be communicatively coupled at any given time. In some embodiments, the at least one computing device 130 may be configured similarly and function similarly to the at least one computing device 122 of the aircraft 102, except that the at least one computing device 130 is located offboard of the aircraft 102. In some embodiments, the at least one display unit 132 may be configured similarly and function similarly to the at least one display unit 110 of the aircraft 102, except that the at least one display unit 132 is located offboard of the aircraft 102. In some embodiments, the at least one communication system 128 may be configured similarly and function similarly to the at least one communication system 128 of the aircraft 102, except that the at least one communication system 128 is located offboard of the aircraft 102.

For example, at least one processor (e.g., the at least one processor (e.g., 108, 119, 124) may be configured to (e.g., collectively configured to, if more than one processor): receive at least some of the images from one or more of the at least one VS sensor unit (e.g., at least one electronic vision system (EVS) sensor unit 104), wherein one or more of the at least some of the images include views of a runway environment; generate real-time display images, wherein each of one or more of the display images have display symbols overlaid on one of (a) a given image of the one or more of the at least some of the images or (b) an image associated with the given image, wherein the display symbols comprise a flight path vector (FPV) symbol and a flight director (FD) symbol, wherein at least one portion of the FPV symbol is hidden or removed from a given display image of the one or more of the display images such that the FPV symbol does not occlude at least one portion of the runway environment, wherein at least one portion of the FD symbol is hidden or removed from the given display image of the one or more of the display images such that the FD symbol does not occlude at least one other portion of the runway environment; output one or more of the display images to one or more of the at least one display unit 110, the at least one display image including the given display image; and/or cause the display device 112 to display at least one display image of the one or more of the display images to a user.

In some embodiments, the at least one portion of the FPV symbol is at least two portions of the FPV symbol, and the at least two portions of the FPV symbol are hidden or removed from the given display image of the one or more of the display images such that the FPV symbol does not occlude the at least one portion of the runway environment.

In some embodiments, the at least one portion of the FPV symbol is at least two portions of the FPV symbol, and the at least two portions of the FPV symbol are hidden or removed from the given display image of the one or more of the display images such that the FPV symbol does not occlude the at least one portion of the runway environment.

In some embodiments, the FPV symbol comprises a circular section and line segments, each of the line segments extending in a normal direction away from the circular section. In some embodiments, the at least one portion of the FPV symbol comprises at least one circular portion of the circular section and/or at least one line segment portion of the line segments. In some embodiments, the at least one portion of the FPV symbol comprises the at least one circular portion of the circular section and the at least one line segment portion of the line segments. In some embodiments, the at least one portion of the FPV symbol further comprises a first circular portion of the at least one circular portion of the circular section, wherein the first circular portion has less than 180 degrees of arc.

In some embodiments, the at least one portion of the FD symbol is at least two portions of the FD symbol, and the at least two portions of the FD symbol are hidden or removed from the given display image of the one or more of the display images such that the FD symbol does not occlude the at least one other portion of the runway environment.

In some embodiments, the at least one portion of the FD symbol is at least two portions of the FD symbol, and the at least two portions of the FD symbol are hidden or removed from the given display image of the one or more of the display images such that the FD symbol does not occlude the at least one other portion of the runway environment.

In some embodiments, the FD symbol comprises a circular section. In some embodiments, the at least one portion of the FD symbol comprises at least one circular portion of the circular section, the at least one circular portion comprising a first circular portion, and the first circular portion has less than 180 degrees of arc.

In some embodiments, the display symbols further comprise content showing information associated with at least one aircraft state (e.g., altitude, airspeed, attitude, and/or navigation).

In some embodiments, one or more of the at least one display unit 110 is at least one pilot display unit (PDU), the at least one PDU comprising a first PDU configured to display the at least one display image of the one or more of the display images to the user, wherein the user is a pilot, wherein the first PDU comprises an overhead unit and a combiner 118. In some embodiments, the at least one computing device 122 comprises at least one head-up display (HUD) computing device, wherein the display symbols are HUD symbols.

In some embodiments, one or more of the at least one display unit 110 comprises at least one head down display.

In some embodiments, one or more of the at least one display unit 110 comprises at least one head wearable display device (e.g., a visor display device and/or a helmet-mounted display (HMD) device).

In some embodiments, one or more of the at least one display unit 110 is installed onboard the aircraft 102.

In some embodiments, one or more of the at least one display unit 110 is installed offboard of the aircraft 102.

In some embodiments, the at least one processor 124 is further configured to, for each of the one or more display images and based at least on current avionics information associated with the aircraft, adjust in real time a depiction of the FPV symbol and/or the FD symbol such that (a) one or more portions of the FPV symbol are hidden or removed so as to prevent the FPV symbol from occluding one or more portions of the runway environment and (b) one or more portions of the one or more portions of the FD symbol are hidden or removed so as to prevent the FD symbol from occluding one or more other portions of the runway environment.

The at least one processor (e.g., 108, 119, 124, and/or the at least one processor of the at least one display unit 132 and/or of the computing device 130) may be configured to (e.g., collectively configured to, if more than one processor) perform any or all of the operations disclosed throughout.

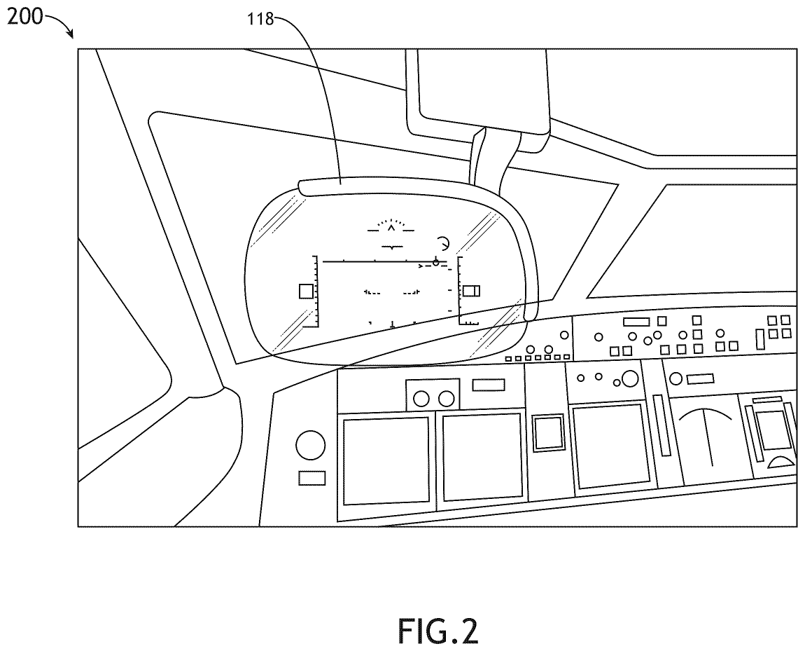

Referring now to FIG. 2, an exemplary embodiment of a cockpit 200 of an aircraft 102 of the system of FIG. 1 is shown according to the inventive concepts disclosed herein. For example, the display unit 110 may be a PDU having a HUD computing device and an overhead unit including a projector 116 and a combiner 118.

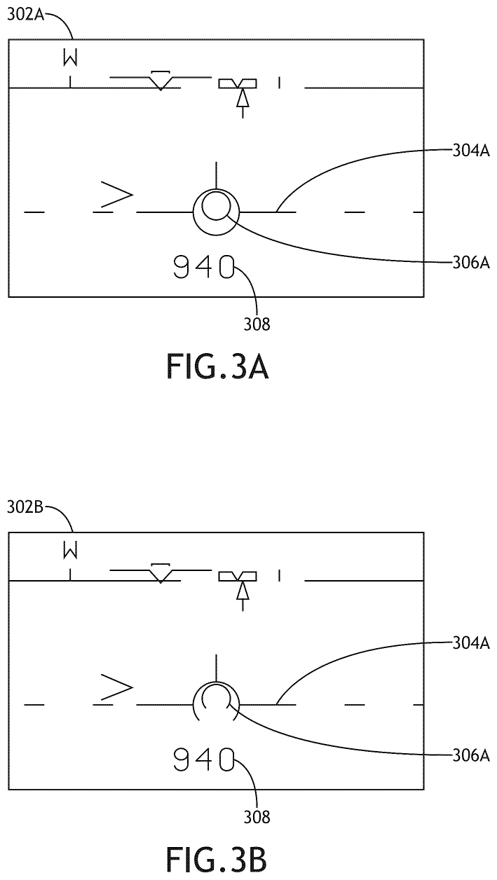

Referring now to FIGS. 3A and 3B, exemplary embodiments of exemplary display images 302A, 302B displayed by a display unit 110 of FIG. 1 at different times are shown according to the inventive concepts disclosed herein. For example, the display images 302A, 302B may include HUD symbols (e.g., a typical FPV symbol 304A, a typical FD symbol 306A, a modified FPV symbol 304B, and/or a modified FD symbol 306B) and/or a current altitude 308 of the aircraft 102. For example, FIG. 3A shows the display image 302A for a situation where neither a typical FPV symbol 304A nor a typical FD symbol 306A occludes any portion of a runway environment. For example, FIG. 3B shows the display image 302B for a situation where both a modified FPV symbol 304B and a modified FD symbol 306B have been modified by at least one processor to prevent occlusion of the runway environment by the modified FPV symbol 304B and the modified FD symbol 306B.

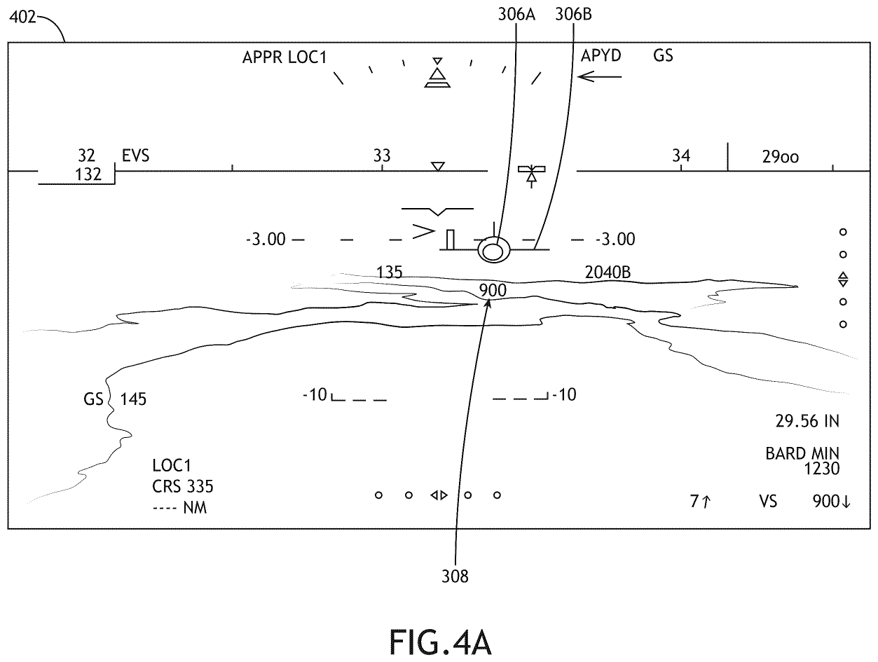

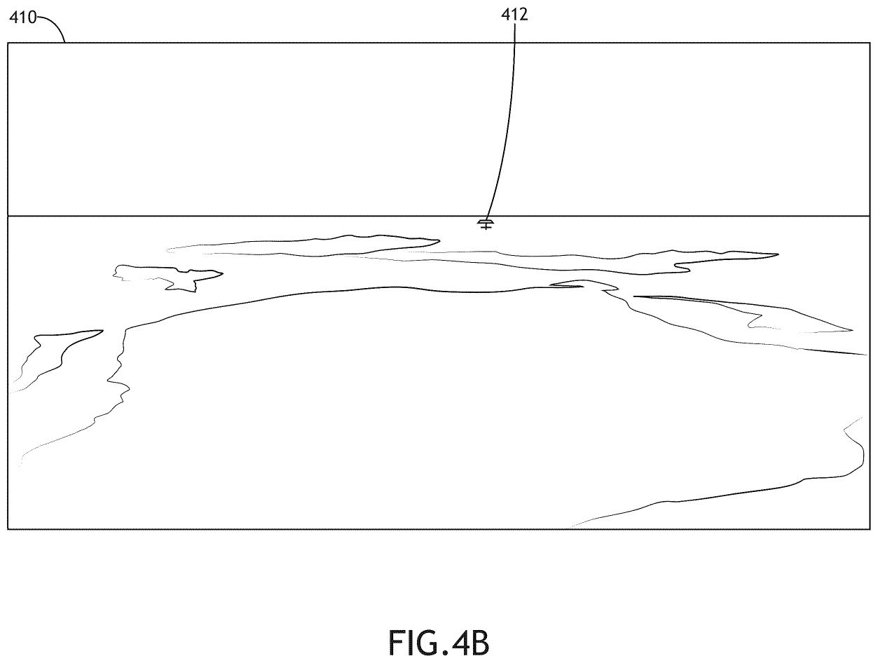

Referring now to FIG. 4A, an exemplary embodiment of an exemplary display image 402 at a first time when an FPV symbol 304A and an FD symbol 306A does not occlude a portion of a runway environment is shown according to the inventive concepts disclosed herein.

Referring now to FIG. 4B, an exemplary embodiment of an exemplary image 410 associated with the display image of FIG. 4A that depicts at least runway lights 412 is shown according to the inventive concepts disclosed herein.

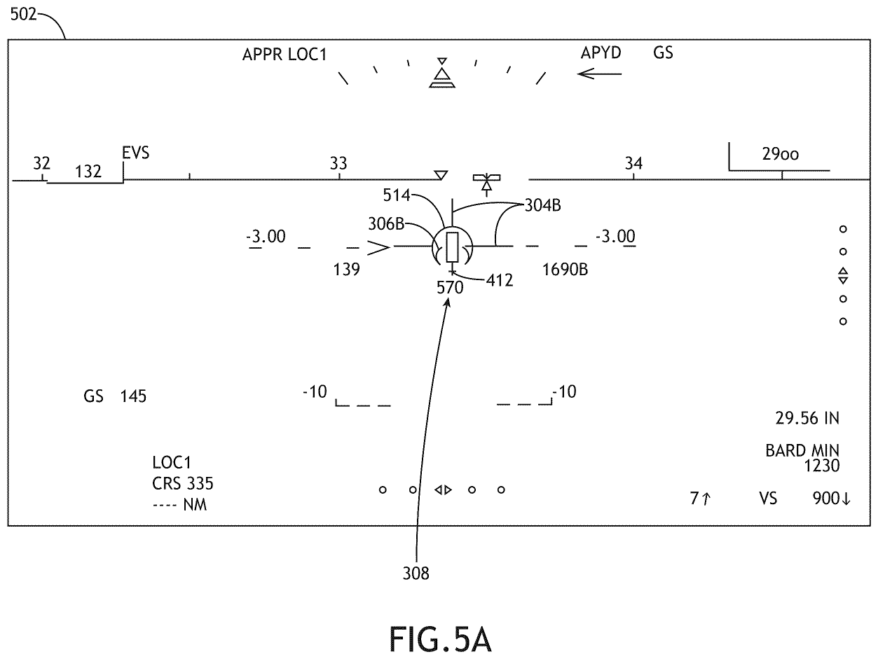

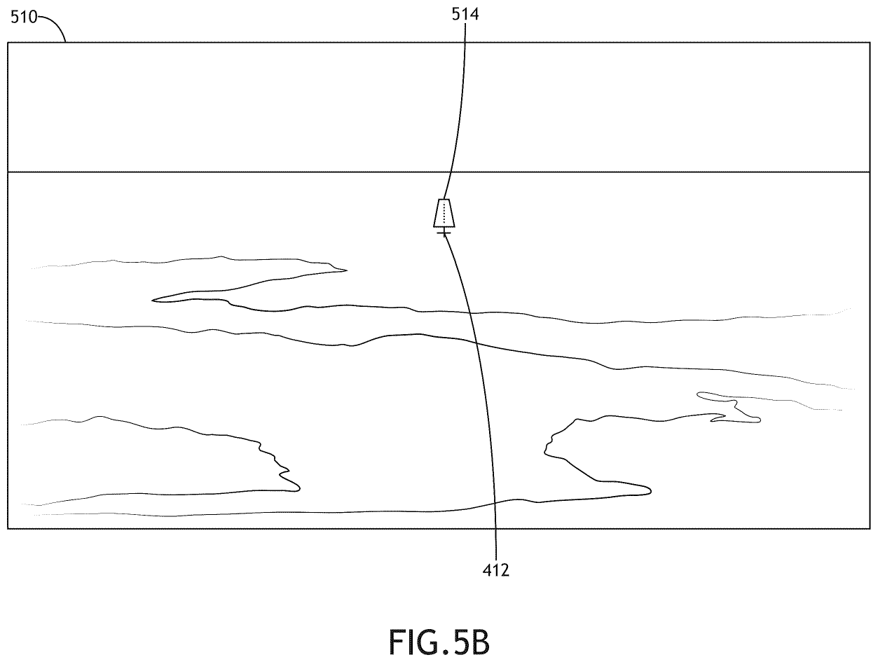

Referring now to FIG. 5A, an exemplary embodiment of an exemplary display image 502 at a second time, when the FPV symbol 304B and the FD symbol 306B have hidden or removed portions so as to prevent occlusion of a portion of a runway 514 or of runway lights 412, is shown according to the inventive concepts disclosed herein.

Referring now to FIG. 5B, an exemplary embodiment of an exemplary image 510 associated with the display image 502 of FIG. 5A is shown according to the inventive concepts disclosed herein.

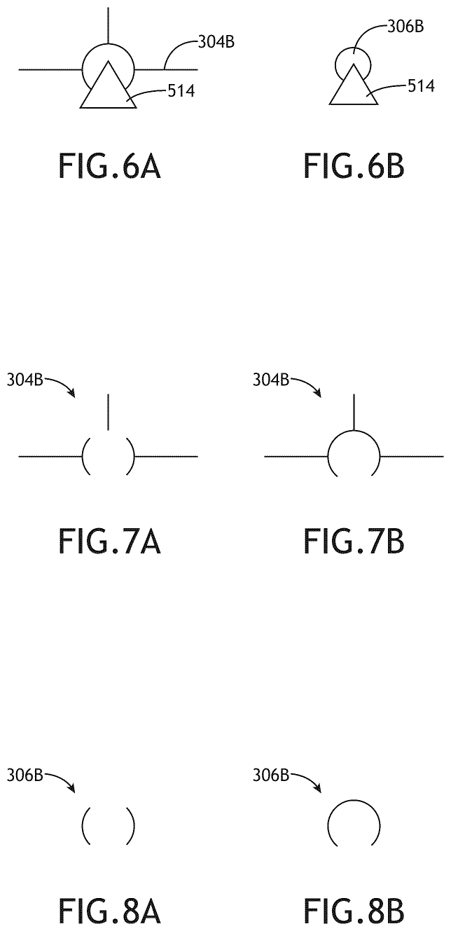

Referring now to FIGS. 6A, 6B, 7A, 7B, 8A, and 8B, exemplary embodiments of the FPV symbol 304B and the FD symbol 306B having hidden or removed portions, so as to prevent occlusion of a portion(s) of a runway 514 and/or of runway lights 412, are shown according to the inventive concepts disclosed herein. For example, the removed portion(s) of the FPV symbol 304B may be any suitable number of portion(s) of the FPV symbol 304B, and each removed portion may span any suitable degrees (e.g., between zero and 180 degrees) of arc. For example, the removed portion(s) of the FD symbol 306B may be any suitable number of portion(s) of the FD symbol 304B, and each removed portion of the FD symbol 306B may span any suitable degrees (e.g., between zero and 180 degrees) of arc and/or any suitable amount of the FD symbol 306B.

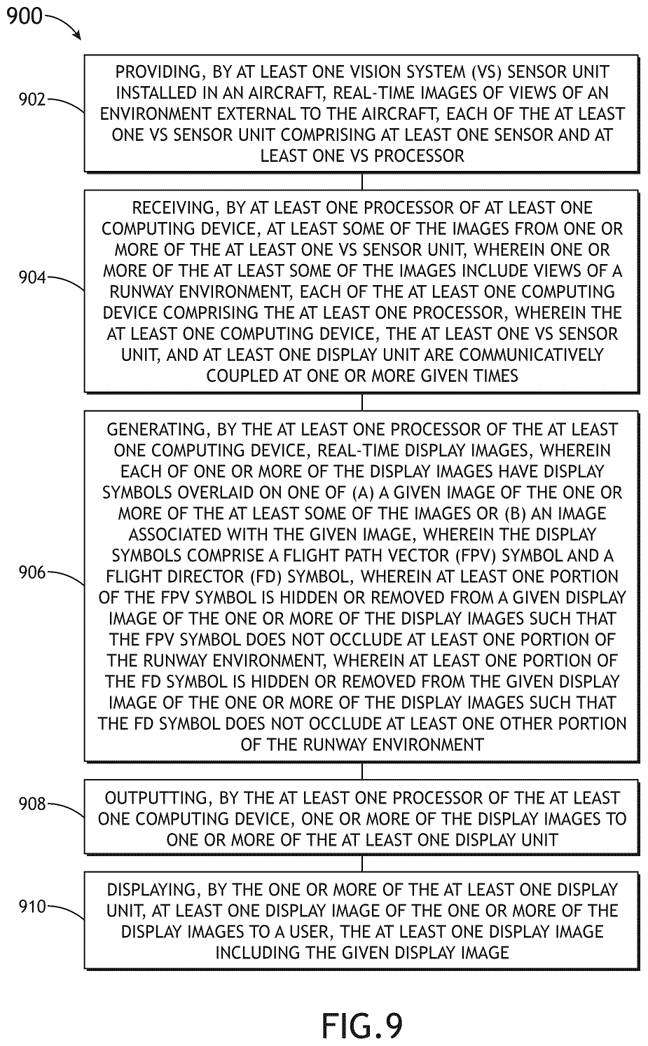

Referring now to FIG. 9, an exemplary embodiment of a method 900 according to the inventive concepts disclosed herein may include one or more of the following steps. Additionally, for example, some embodiments may include performing one or more instances of the method 900 iteratively, concurrently, and/or sequentially. Additionally, for example, at least some of the steps of the method 900 may be performed in parallel and/or concurrently. Additionally, in some embodiments, at least some of the steps of the method 900 may be performed non-sequentially.

A step 902 may include providing, by at least one vision system (VS) sensor unit installed in an aircraft, real-time images of views of an environment external to the aircraft, each of the at least one VS sensor unit comprising at least one sensor and at least one VS processor.

A step 904 may include receiving, by at least one processor of at least one computing device, at least some of the images from one or more of the at least one VS sensor unit, wherein one or more of the at least some of the images include views of a runway environment, each of the at least one computing device comprising the at least one processor, wherein the at least one computing device, the at least one VS sensor unit, and at least one display unit are communicatively coupled at one or more given times.

A step 906 may include generating, by the at least one processor of the at least one computing device, real-time display images, wherein each of one or more of the display images have display symbols overlaid on one of (a) a given image of the one or more of the at least some of the images or (b) an image associated with the given image, wherein the display symbols comprise a flight path vector (FPV) symbol and a flight director (FD) symbol, wherein at least one portion of the FPV symbol is hidden or removed from a given display image of the one or more of the display images such that the FPV symbol does not occlude at least one portion of the runway environment, wherein at least one portion of the FD symbol is hidden or removed from the given display image of the one or more of the display images such that the FD symbol does not occlude at least one other portion of the runway environment.

A step 908 may include outputting, by the at least one processor of the at least one computing device, one or more of the display images to one or more of the at least one display unit.

A step 910 may include displaying, by the one or more of the at least one display unit, at least one display image of the one or more of the display images to a user, the at least one display image including the given display image.

Further, the method 900 may include any of the operations disclosed throughout.

As will be appreciated from the above, embodiments of the inventive concepts disclosed herein may be directed to a system (e.g., an aircraft system or a system including an aircraft and an offboard device) and a method configured to generate and/or display real-time display images. Each of one or more of the display images may have display symbols overlaid on one of a image or an image associated with the image. The display symbols may comprise a flight path vector (FPV) symbol and a flight director (FD) symbol, wherein at least one portion of the FPV and/or of the FD symbol is hidden or removed from a given display image of the one or more of the display images such that the FPV and/or FD symbol does not occlude at least one portion of the runway environment (e.g., a runway, runway threshold, runway lights, and/or a touchdown zone).

As used throughout and as would be appreciated by those skilled in the art, “at least one non-transitory computer-readable medium” may refer to as at least one non-transitory computer-readable medium (e.g., at least one computer-readable medium implemented as hardware; e.g., at least one non-transitory processor-readable medium, at least one memory (e.g., at least one nonvolatile memory, at least one volatile memory, or a combination thereof; e.g., at least one random-access memory, at least one flash memory, at least one read-only memory (ROM) (e.g., at least one electrically erasable programmable read-only memory (EEPROM)), at least one on-processor memory (e.g., at least one on-processor cache, at least one on-processor buffer, at least one on-processor flash memory, at least one on-processor EEPROM, or a combination thereof), or a combination thereof), at least one storage device (e.g., at least one hard-disk drive, at least one tape drive, at least one solid-state drive, at least one flash drive, at least one readable and/or writable disk of at least one optical drive configured to read from and/or write to the at least one readable and/or writable disk, or a combination thereof), or a combination thereof).

As used throughout, “at least one” means one or a plurality of; for example, “at least one” may comprise one, two, three, . . . , one hundred, or more. Similarly, as used throughout, “one or more” means one or a plurality of; for example, “one or more” may comprise one, two, three, . . . , one hundred, or more. Further, as used throughout, “zero or more” means zero, one, or a plurality of; for example, “zero or more” may comprise zero, one, two, three, . . . , one hundred, or more.

In the present disclosure, the methods, operations, and/or functionality disclosed may be implemented as sets of instructions or software readable by a device. Further, it is understood that the specific order or hierarchy of steps in the methods, operations, and/or functionality disclosed are examples of exemplary approaches. Based upon design preferences, it is understood that the specific order or hierarchy of steps in the methods, operations, and/or functionality can be rearranged while remaining within the scope of the inventive concepts disclosed herein. The accompanying claims may present elements of the various steps in a sample order and are not necessarily meant to be limited to the specific order or hierarchy presented.

It is to be understood that embodiments of the methods according to the inventive concepts disclosed herein may include one or more of the steps described herein. Further, such steps may be carried out in any desired order and two or more of the steps may be carried out simultaneously with one another. Two or more of the steps disclosed herein may be combined in a single step, and in some embodiments, one or more of the steps may be carried out as two or more sub-steps. Further, other steps or sub-steps may be carried in addition to, or as substitutes to one or more of the steps disclosed herein.

From the above description, it is clear that the inventive concepts disclosed herein are well adapted to carry out the objects and to attain the advantages mentioned herein as well as those inherent in the inventive concepts disclosed herein. While presently preferred embodiments of the inventive concepts disclosed herein have been described for purposes of this disclosure, it will be understood that numerous changes may be made which will readily suggest themselves to those skilled in the art and which are accomplished within the broad scope and coverage of the inventive concepts disclosed and claimed herein.

What is claimed is:

1. A system, comprising:
at least one display unit;
at least one vision system (VS) sensor unit installed in an aircraft, each of the at least one VS sensor unit comprising at least one sensor and at least one VS processor, wherein the at least one VS sensor unit is configured to provide real-time images of views of an environment external to the aircraft; and
at least one computing device, each of the at least one computing device comprising at least one processor, wherein the at least one computing device, the at least one VS sensor unit, and the at least one display unit are communicatively coupled at one or more given times, wherein the at least one computing device is configured to:
receive at least some of the images from one or more of the at least one VS sensor unit, wherein one or more of the at least some of the images include views of a runway environment;
generate real-time display images, wherein each of one or more of the display images have display symbols overlaid on one of (a) a given image of the one or more of the at least some of the images or (b) an image associated with the given image, wherein the display symbols comprise a flight path vector (FPV) symbol and a flight director (FD) symbol, wherein at least one portion of the FPV symbol is hidden or removed from a given display image of the one or more of the display images such that the FPV symbol does not occlude at least one portion of the runway environment, wherein at least one portion of the FD symbol is hidden or removed from the given display image of the one or more of the display images such that the FD symbol does not occlude at least one other portion of the runway environment; and
output one or more of the display images to one or more of the at least one display unit;
wherein the one or more of the at least one display unit is configured to display at least one display image of the one or more of the display images to a user, the at least one display image including the given display image.

2. The system of claim 1, wherein the at least one portion of the FPV symbol is at least two portions of the FPV symbol, wherein the at least two portions of the FPV symbol are hidden or removed from the given display image of the one or more of the display images such that the FPV symbol does not occlude the at least one portion of the runway environment.

3. The system of claim 1, wherein the at least one portion of the FPV symbol is at least two portions of the FPV symbol, wherein the at least two portions of the FPV symbol are hidden or removed from the given display image of the one or more of the display images such that the FPV symbol does not occlude the at least one portion of the runway environment.

4. The system of claim 1, wherein the FPV symbol comprises a circular section and line segments, each of the line segments extending in a normal direction away from the circular section.

5. The system of claim 4, wherein the at least one portion of the FPV symbol comprises at least one circular portion of the circular section and/or at least one line segment portion of the line segments.

6. The system of claim 5, wherein the at least one portion of the FPV symbol comprises the at least one circular portion of the circular section and the at least one line segment portion of the line segments.

7. The system of claim 5, wherein the at least one portion of the FPV symbol further comprises a first circular portion of the at least one circular portion of the circular section, wherein the first circular portion has less than 180 degrees of arc.

8. The system of claim 1, wherein the at least one portion of the FD symbol is at least two portions of the FD symbol, wherein the at least two portions of the FD symbol are hidden or removed from the given display image of the one or more of the display images such that the FD symbol does not occlude the at least one other portion of the runway environment.

9. The system of claim 1, wherein the at least one portion of the FD symbol is at least two portions of the FD symbol, wherein the at least two portions of the FD symbol are hidden or removed from the given display image of the one or more of the display images such that the FD symbol does not occlude the at least one other portion of the runway environment.

10. The system of claim 1, wherein the FD symbol comprises a circular section.

11. The system of claim 10, wherein the at least one portion of the FD symbol comprises at least one circular portion of the circular section, the at least one circular portion comprising a first circular portion, wherein the first circular portion has less than 180 degrees of arc.

12. The system of claim 1, wherein the display symbols further comprise content showing information associated with altitude.

13. The system of claim 1, wherein one or more of the at least one display unit is at least one pilot display unit (PDU), the at least one PDU comprising a first PDU configured to display the at least one display image of the one or more of the display images to the user, wherein the user is a pilot, the first PDU comprising an overhead unit and a combiner.

14. The system of claim 13, wherein the at least one computing device comprises at least one head-up display (HUD) computing device, wherein the display symbols are HUD symbols.

15. The system of claim 1, wherein one or more of the at least one display unit comprises at least one head down display.

16. The system of claim 1, wherein one or more of the at least one display unit comprises at least one head wearable display device.

17. The system of claim 1, wherein one or more of the at least one display unit is installed onboard the aircraft.

18. The system of claim 1, wherein one or more of the at least one display unit is installed offboard of the aircraft.

19. The system of claim 1, wherein the at least one processor is further configured to, for each of the one or more display images and based at least on current avionics information associated with the aircraft, adjust in real time a depiction of the FPV symbol and/or the FD symbol such that (a) one or more portions of the FPV symbol are hidden or removed so as to prevent the FPV symbol from occluding one or more portions of the runway environment and (b) one or more portions of the FD symbol are hidden or removed so as to prevent the FD symbol from occluding one or more other portions of the runway environment.

20. A method, comprising:
providing, by at least one vision system (VS) sensor unit installed in an aircraft, real-time images of views of an environment external to the aircraft, each of the at least one VS sensor unit comprising at least one sensor and at least one VS processor;
receiving, by at least one processor of at least one computing device, at least some of the images from one or more of the at least one VS sensor unit, wherein one or more of the at least some of the images include views of a runway environment, each of the at least one computing device comprising the at least one processor, wherein the at least one computing device, the at least one VS sensor unit, and at least one display unit are communicatively coupled at one or more given times;
generating, by the at least one processor of the at least one computing device, real-time display images, wherein each of one or more of the display images have display symbols overlaid on one of (a) a given image of the one or more of the at least some of the images or (b) an image associated with the given image, wherein the display symbols comprise a flight path vector (FPV) symbol and a flight director (FD) symbol, wherein at least one portion of the FPV symbol is hidden or removed from a given display image of the one or more of the display images such that the FPV symbol does not occlude at least one portion of the runway environment, wherein at least one portion of the FD symbol is hidden or removed from the given display image of the one or more of the display images such that the FD symbol does not occlude at least one other portion of the runway environment;
outputting, by the at least one processor of the at least one computing device, one or more of the display images to one or more of the at least one display unit; and
displaying, by the one or more of the at least one display unit, at least one display image of the one or more of the display images to a user, the at least one display image including the given display image.
